(19) United States
(12) Patent Application Publication
(10) Pub. No.: US 2005/0231452 A1
(43) Pub. Date: Oct. 20, 2005

(54) Drive circuit with offset compensation capability, and liquid crystal display using the same

(75) Inventor: Youichi Tobita, Hyogo (JP)

Correspondence Address: BUCHANAN INGERSOLL PC;(INCLUDING BURNS, DOANE, SWECKER & MATHIS), POST OFFICE BOX 1404, ALEXANDRIA, VA, 22313-1404, US

(73) Assignee: Mitsubishi Denki Kabushiki Kaisha, Tokyo (JP)

(21) Appl. No.: 11/066,152

(22) Filed: Feb. 25, 2005

(30) Foreign Application Priority Data
Apr. 15, 2004 (JP) 2004-119997

(51) Int. Cl. G09G 3/36

(52) U.S. Cl. 345/87

(57) ABSTRACT

In an analog amplifier unit circuit included in a color liquid crystal display, an aluminum interconnection is formed to cover a gate electrode of an input transistor of a drive circuit, and capacitance between the gate electrode and the aluminum interconnection is used as an offset-compensating capacitor. Thus, the parasitic capacitance of the gate electrode of the input transistor can be made small, and the offset voltage can be canceled accurately, without increasing the area occupied by a capacitor.

### BACKGROUND OF THE INVENTION

1. Field of the Invention

The present invention relates to a drive circuit having offset compensation capability and a liquid crystal display using the same. More particularly, the present invention relates to a drive circuit having offset compensation capability that outputs a potential corresponding to an input potential, and a liquid crystal display using the same.

2. Description of the Background Art

There has conventionally been proposed an offset compensation circuit that cancels an offset voltage of a drive circuit. In the offset compensation circuit, a capacitor is charged to the offset voltage, and the capacitor is connected to an input node of the drive circuit to compensate the offset voltage (see, e.g., Japanese Patent Laying-Open No. 2000-114889).

In the conventional offset compensation circuit, however, there occurs a loss of the voltage of the capacitor due to an influence of parasitic capacitance of the input node of the drive circuit, hindering accurate cancellation of the offset voltage.

If the capacitance value of the capacitor is made sufficiently greater than the parasitic capacitance, the voltage loss can be made small. To do so, however, the area of the capacitor needs to be made large, which leads to an increase of the area occupied by the offset compensation circuit. This poses a serious problem particularly when using the offset compensation circuit for a data line drive circuit of a liquid crystal display, since a great number of offset compensation circuits are necessary.

### SUMMARY OF THE INVENTION

In view of the foregoing, a major object of the present invention is to provide a drive circuit having offset compensation capability that occupies a small area and can accurately cancel an offset voltage, and a liquid crystal display using the same.

A drive circuit having offset compensation capability according to the present invention includes: a drive circuit, including a first transistor having a gate electrode connected to an input node, and outputting a potential corresponding to a potential of the input node to an output node; and an offset compensation circuit, including a first capacitor charged to an offset voltage of the drive circuit, and compensating the offset voltage. Here, the first capacitor includes a first electrode that is the gate electrode of the first transistor, and a second electrode provided to face the first electrode.

As such, the gate electrode of the input transistor of the drive circuit is used as one electrode of an offset-compensating capacitor. Accordingly, the parasitic capacitance of the gate of the input transistor can be made small, and the offset voltage can be compensated accurately, without increasing the area occupied.

Another drive circuit having offset compensation capability according to the present invention includes: a drive circuit including a transistor having a gate electrode connected to an input node, and outputting a potential corresponding to a potential of the input node to an output node; and an offset compensation circuit including a capacitor charged to an offset voltage of the drive circuit, and compensating the offset voltage. Here, the capacitor includes a first electrode connected to the gate electrode of the transistor, a second electrode formed on a lower side of the first electrode with an insulating layer interposed therebetween, and a third electrode formed on an upper side of the first electrode with an insulating layer interposed therebetween, and connected to the second electrode.

As such, one electrode of the offset-compensating capacitor, connected to the gate electrode of the input transistor of the drive circuit, is provided between two other electrodes. Accordingly, the parasitic capacitance of the gate of the input transistor can be made small, and the offset voltage can be compensated accurately, without increasing the area occupied.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a block diagram showing an overall configuration of a color liquid crystal display according to a first embodiment of the present invention.

FIG. 2 is a circuit diagram showing a configuration of a liquid crystal drive circuit provided corresponding to each liquid crystal cell shown in FIG. 1.

FIG. 3 is a circuit block diagram showing a configuration of a horizontal scanning circuit shown in FIG. 1.

FIG. 4 is a circuit diagram showing a configuration of an analog amplifier unit circuit included in an analog amplifier shown in FIG. 3.

FIG. 5 shows a layout of an N type transistor 21 and a capacitor 23 shown in FIG. 4.

FIG. 6 is a cross sectional view taken along the line VI-VI of FIG. 5.

FIG. 7 is a circuit diagram showing a comparative example of the first embodiment.

FIG. 8 is a cross sectional view showing a configuration of an N type transistor 21 shown in FIG. 7.

FIG. 9 is a circuit diagram showing a main part of an analog amplifier unit circuit according to a second embodiment of the present invention.

FIGS. 10-15 are circuit diagrams showing modifications of the second embodiment of the present invention.

FIG. 16 is a circuit diagram showing a configuration of an analog amplifier unit circuit according to a third embodiment of the present invention.

FIG. 17 is a circuit diagram showing a configuration of an analog amplifier unit circuit according to a fourth embodiment of the present invention.

FIG. 18 is a circuit diagram showing a configuration of an analog amplifier unit circuit according to a fifth embodiment of the present invention.

FIG. 19 shows a layout of an N type transistor 21 and capacitors 23, 24 and 86 shown in FIG. 18.

FIG. 20 is a cross sectional view taken along the line XX-XX of FIG. 19.

### DESCRIPTION OF THE PREFERRED EMBODIMENTS

### First Embodiment

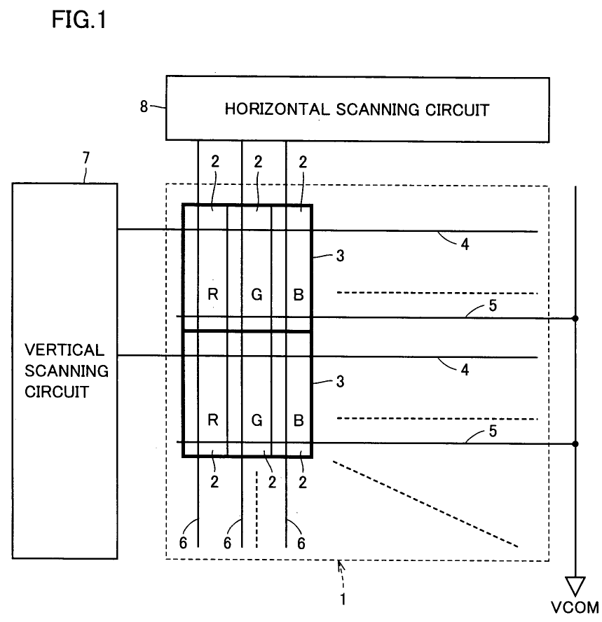

FIG. 1 shows a configuration of a color liquid crystal display according to the first embodiment of the present invention. Referring to FIG. 1, the color liquid crystal display includes a liquid crystal panel 1, a vertical scanning circuit 7 and a horizontal scanning circuit 8, and is provided to a mobile telephone, for example.

Liquid crystal panel 1 includes a plurality of liquid crystal cells 2 arranged in rows and columns, a gate line 4 and a common potential line 5 provided corresponding to each row, and a data line 6 provided corresponding to each column. In each row, liquid crystal cells 2 are grouped into three each in advance. Three liquid crystal cells 2 in each group are provided with color filters of R, G and B, respectively. Three liquid crystal cells 2 in each group constitute one pixel 3.

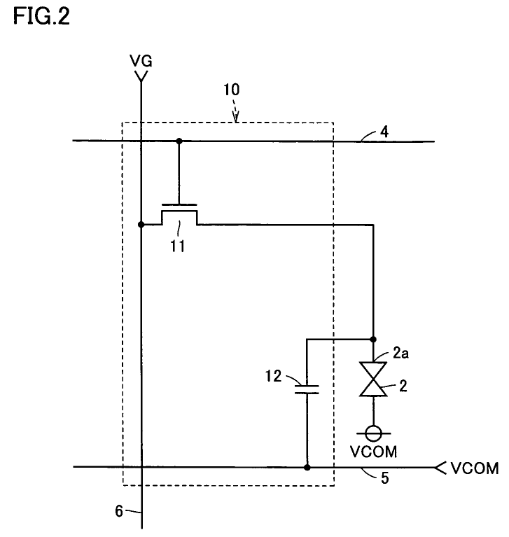

A liquid crystal drive circuit 10 is provided for each liquid crystal cell 2, as shown in FIG. 2. Liquid crystal drive circuit 10 includes an N type transistor 11 and a capacitor 12. N type transistor 11 is connected between data line 6 and one electrode 2a of liquid crystal cell 2, and has its gate connected to gate line 4. Capacitor 12 is connected between the one electrode 2a of liquid crystal cell 2 and common potential line 5. The other electrode of liquid crystal cell 2 is provided with a common potential VCOM. Common potential line 5 is provided with common potential VCOM.

Returning to FIG. 1, vertical scanning circuit 7 successively selects a plurality of gate lines 4, each for a predetermined period of time, in accordance with an image signal, and drives the selected gate line 4 to an “H” level of a selected level. When gate line 4 is set to an “H” level of the selected level, N type transistor 11 in FIG. 2 is rendered conductive, and the one electrode 2a of each liquid crystal cell 2 corresponding to the gate line 4 is coupled to data line 6 corresponding to the relevant liquid crystal cell 2.

Horizontal scanning circuit 8 provides a gradation potential VG to each data line 6 while one gate line 4 is selected by vertical scanning circuit 7, in accordance with an image signal. Optical transmittance of liquid crystal cell 2 changes in accordance with the level of gradation potential VG. When all liquid crystal cells 2 of liquid crystal panel 1 are scanned by vertical scanning circuit 7 and horizontal scanning circuit 8, one image is displayed on liquid crystal panel 1.

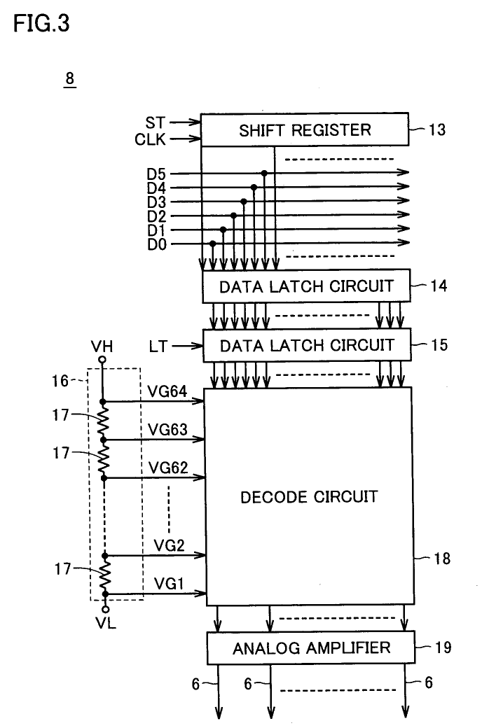

FIG. 3 shows a configuration of horizontal scanning circuit 8. Referring to FIG. 3, horizontal scanning circuit 8 includes a shift register 13, data latch circuits 14, 15, a gradation potential generating circuit 16, a decode circuit 18, and an analog amplifier 19. Shift register 13 controls data latch circuit 14 in synchronization with a start signal ST and a clock signal CLK. Data latch circuit 14 is controlled by shift register 13, and successively latches image data signals D0-D5, for one data line 6 at a time, and latches image data signals D0-D5 for one row. Data latch circuit 15 is controlled by a latch signal LT, and latches image data signals D0-D5 for one row, having been latched by data latch circuit 14, at a time.

Gradation potential generating circuit 16 includes a plurality of resistance elements 17 connected in series, and divides a voltage between a high potential VH and a low potential VL to generate 64 gradation potentials VG1-VG64. Decode circuit 18 selects one of 64 gradation potentials VG1-VG64 for each data line 6, in accordance with image data signals D0-D5 provided from data latch circuit 15, and supplies the selected gradation potential to analog amplifier 19. Analog amplifier 19 current-amplifies each gradation potential provided from decode circuit 18, and provides the resultant potential to corresponding data line 6.

Analog amplifier 19 includes analog amplifier unit circuits of the same number as data lines 6. Each analog amplifier unit circuit has high input impedance and low output impedance, and current-amplifies the input potential and outputs a potential equal to the input potential.

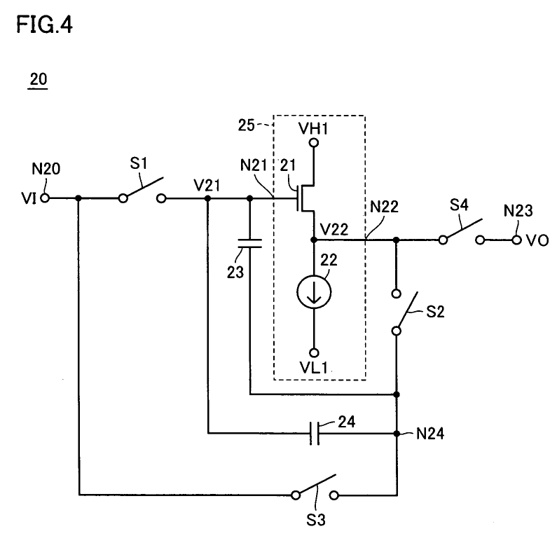

FIG. 4 shows a configuration of an analog amplifier unit circuit 20. Referring to FIG. 4, analog amplifier unit circuit 20 includes an N type transistor 21, a constant current circuit 22, capacitors 23, 24, and switches S1-S4.

N type transistor 21 is connected between a line of a high potential VH1 and a node N22, and has its gate electrode connected to a node N21. Constant current circuit 22 is connected between node N22 and a line of a low potential VL1, and causes a current of a prescribed value to flow from node N22 to the line of low potential VL1 N type transistor 21 and constant current circuit 22 constitute a drive circuit 25.

The drive current of N type transistor 21 is set sufficiently smaller than the current value of constant current circuit 22. Thus, N type transistor 21 performs a source-follower operation, and a potential V22 of node N22 becomes lower than a voltage V21 of node N21 by a threshold voltage VTN of N type transistor 21, i.e., V22=V21−VTN. As such, an offset voltage VOF of drive circuit 25 becomes: VOF=−VTN.

Switch S1 is connected between an input node N20 and node N21. Switches S3, S2 are connected in series between input node N20 and node N22. Switch S4 is connected between node N22 and an output node N23. Capacitors 23, 24 are connected in parallel between node N21 and a node N24 located between switches S2 and S3. Switches S1-S4 and capacitors 23, 24 constitute an offset compensation circuit for canceling offset voltage VOF of drive circuit 25.

An operation of analog amplifier unit circuit 20 is now explained. Firstly, in the first time period, switches S1, S2 are turned on, and switches S3, S4 are turned off. An input potential VI is provided via switch S1 to the gate electrode of N type transistor 21, and at the same time, capacitors 23, 24 are connected in parallel between nodes N21 and N22 by switch S2. As such, potential V22 of node N22 becomes: V22=VI−VTN, and capacitors 23, 24 are charged to offset voltage VOF=−VTN.

In the second time period following the first time period, switches S1, S2 and S4 are turned off, while switch S3 is turned on. Thus, potential V21 of node N21 becomes: V21=VI+VTN that corresponds to input potential VI from which the terminal-to-terminal voltage VOF=−VTN of capacitors 23, 24 is subtracted. Potential V22 of node N22 becomes: V22=V21−VTN=VI+VTN−VTN=VI. As such, offset voltage VOF of drive circuit 25 is cancelled.

In reality, there is parasitic capacitance of node N21, and thus, potential V21 of node N21 when switch S3 is turned on becomes: V21 VI+VTN−ΔV, and the output potential V22 of drive circuit 25 becomes: V22=VI−ΔV. When a capacitance value of the parasitic capacitance of node N21 is represented as C21 and capacitance values of capacitors 23, 24 are represented as C23, C24, respectively, then the voltage loss ΔV is expressed by the following expression:
ΔV=VOF·C21/(C21+C23+C24) (1)

It is noted that ΔV is sufficiently small in this analog amplifier unit circuit 20, since part of the parasitic capacitance of node N21 is used as capacitor 23, which will be described later in detail. In the third time period following the second time period, switches S1, S2 are turned off and switches S3, S4 are turned on. When ΔV=0, an output potential VO becomes: VO=VI.

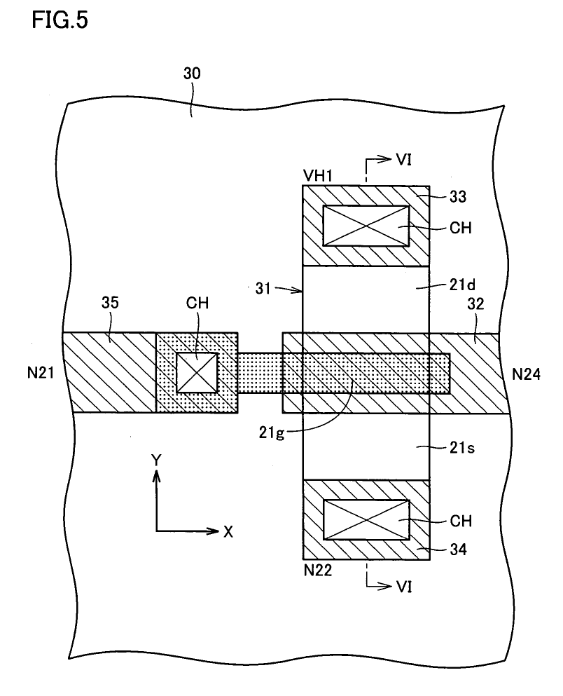

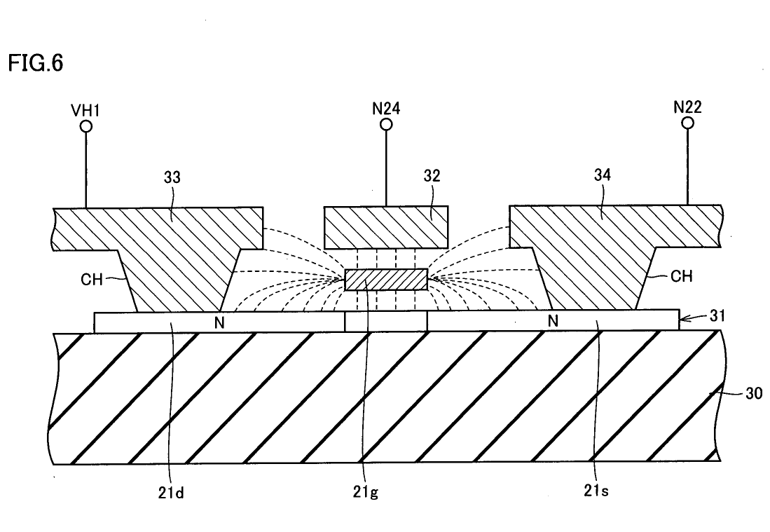

FIG. 5 shows a layout of N type transistor 21 and capacitor 23 shown in FIG. 4. FIG. 6 is a cross sectional view taken along the line VI-VI of FIG. 5. Referring to FIGS. 5 and 6, a strip-shaped polysilicon thin film 31 extending in a Y direction in the figure is formed on a surface of a glass substrate 30, and a gate electrode 21g extending in an X direction in the figure is formed above the center portion of polysilicon thin film 31, with an insulating layer (not shown) interposed therebetween. An impurity is introduced into polysilicon thin film 31, using gate electrode 21g as a mask. The polysilicon thin film on one side of gate electrode 21g becomes a drain 21d, and the polysilicon thin film on the other side of gate electrode 21g becomes a source 21s.

An end portion of gate electrode 21g extends beyond the region of polysilicon thin film 31, and is connected via a contact hole CH and an aluminum interconnection 35 to node N21. Drain 21d is connected via a contact hole CH and an aluminum interconnection 33 to a line of high potential VH1, and source 21s is connected via a contact hole CH and an aluminum interconnection 34 to node N22. An aluminum interconnection 32 is formed above gate electrode 21g with an insulating layer (not shown) interposed therebetween. Aluminum interconnection 32 is connected to node N24. Aluminum interconnection 32 is formed to cover gate electrode 21g.

There exists an electric field between gate electrode 21g and its surroundings, as indicated by dotted lines in FIG. 6. This electric field causes parasitic capacitance. The electric field beneath gate electrode 21g most largely contributes to the parasitic capacitance, which is indispensable for an operation of transistor 21. The electric field on the side and upper surfaces of gate electrode 21g is unnecessary for the operation of transistor 21.

Thus, in the first embodiment, aluminum interconnection 32 is formed to cover gate electrode 21g so as to reduce the parasitic capacitance attributable to the electric field on the side and upper surfaces of gate electrode 21g and to use the capacitance between gate electrode 21g and aluminum interconnection 32 as the capacitor 23 for canceling the offset. In other words, the electric field on the side and upper surfaces of gate electrode 21g having otherwise affected adversely is now made to have a positive influence. The effect is profound.

The electric field between gate electrode 21g and aluminum interconnections 33, 34 can be reduced and thus the parasitic capacitance value can be made smaller as the width of aluminum interconnection 32 in the lateral direction in FIG. 6 is widened. Further, as the distance between gate electrode 21g and aluminum interconnections 33, 34 is increased, the electric field between gate electrode 21g and aluminum interconnections 33, 34 and, hence, the parasitic capacitance value can be reduced.

In the first embodiment, aluminum interconnection 32 is formed to cover gate electrode 21g of the input transistor 21 of drive circuit 25, and the capacitance between gate electrode 21g and aluminum interconnection 32 is used as the offset-compensating capacitor 23. Thus, the parasitic capacitance of gate electrode 21g of input transistor 21 can be reduced, and the offset voltage can be cancelled with accuracy, without increasing the area occupied by capacitor 24.

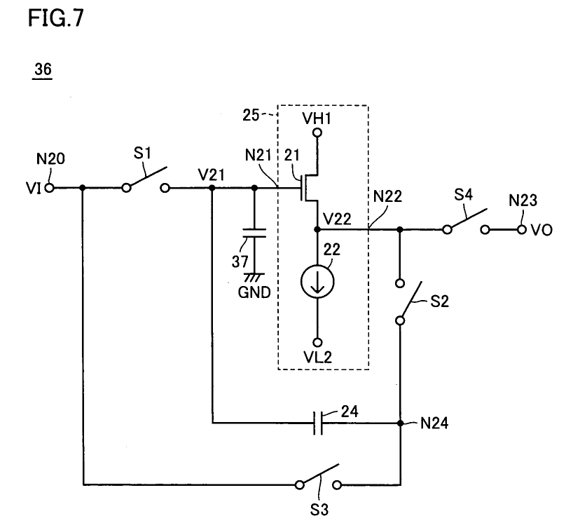

FIG. 7 shows a configuration of an analog amplifier unit circuit 36 as a comparative example of the first embodiment, which is to be contrasted with FIG. 4. Referring to FIG. 7, analog amplifier unit circuit 36 differs from analog amplifier unit circuit 20 of FIG. 4 in that capacitor 23 is not provided. Thus, in analog amplifier unit circuit 36, the gate electrode of N type transistor 21 has large parasitic capacitance, which hinders accurate cancellation of offset voltage VOF. In FIG. 7, a capacitor 37 connected between node N21 and a line of a ground voltage GND represents the parasitic capacitance.

When the capacitance value of capacitor 37 is represented as C37, the voltage loss ΔV explained in conjunction with the expression (1) above is expressed by the following expression:
ΔV=VOF·C37/(C37+C24) (2)

Since C21<C37<C21+C23, and since the expression (1) has a greater denominator and a smaller numerator than the expression (2), voltage loss ΔV of the expression (1) is smaller than that of the expression (2).

FIG. 8 shows a configuration of N type transistor 21 shown in FIG. 7, which is to be contrasted with FIG. 6. In FIG. 8, aluminum interconnection 32 is not provided above gate electrode 21g. Thus, the electric field between the side and upper surfaces of gate electrode 21g and aluminum interconnections 33, 34 is strong, resulting in the large parasitic capacitance of gate electrode 21g.

### Second Embodiment

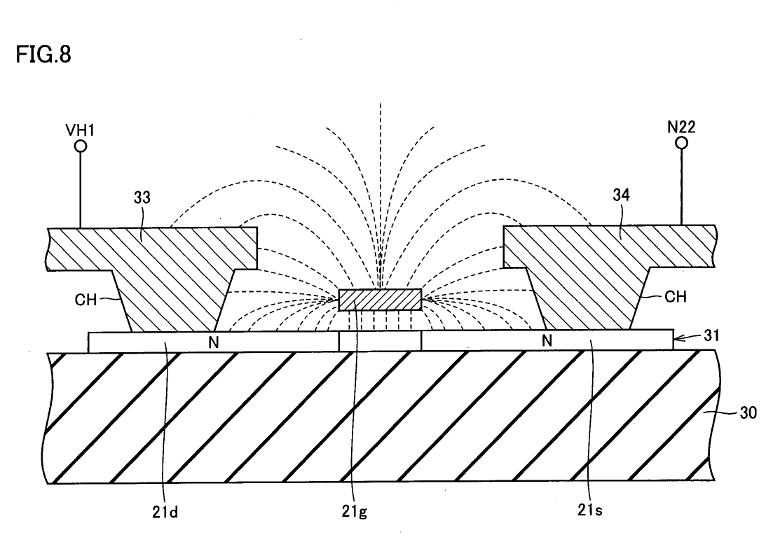

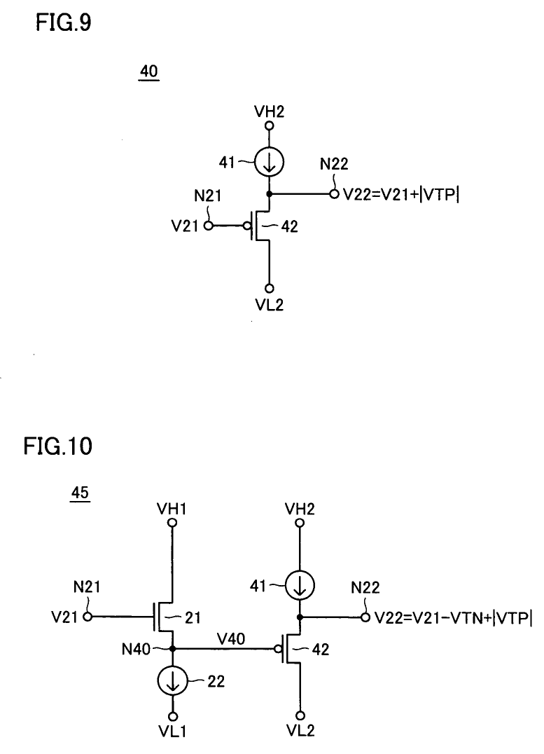

FIG. 9 shows a main part of an analog amplifier unit circuit according to the second embodiment of the present invention. Referring to FIG. 9, the analog amplifier unit circuit of the present embodiment differs from the analog amplifier unit circuit shown in FIG. 4 in that drive circuit 25 is replaced with a drive circuit 40.

Drive circuit 40 includes a constant current circuit 41 and a P type transistor 42. Constant current circuit 41 is connected between a line of a high potential VH2 and node N22, and causes a current of a prescribed value to flow from the line of high potential VH2 to node N22. P type transistor 42 is connected between node N22 and a line of low potential VL2, and has its gate electrode connected to node N21.

The drive current of P type transistor 42 is set sufficiently greater than the current value of constant current circuit 41. Thus, P type transistor 42 carries out the source-follower operation, and potential V22 of node N22 becomes: V22=V21+|VTP| that is higher than potential V21 of node N21 by an absolute value |VTP| of a threshold voltage VTP of P type transistor 42. Thus, the offset voltage VOF of this drive circuit 40 becomes: VOF=|VTP|.

Capacitor 23 shown in FIG. 4 is formed by the gate electrode of P type transistor 42 and aluminum interconnection 32 formed to cover the same, as shown in FIGS. 5 and 6. The other configuration and operation are identical to those of analog amplifier unit circuit 20 shown in FIGS. 4-6, and thus, description thereof is not repeated.

With the second embodiment as well, effects similar to those of the first embodiment can be obtained.

Hereinafter, various modifications of the second embodiment will be described. A drive circuit 45 shown in FIG. 10 is a combination of drive circuit 25 of FIG. 4 and drive circuit 40 of FIG. 9. The gate of P type transistor 42 receives a potential V40 of a node N40 between N type transistor 21 and constant current circuit 22. V40=V21−VTN, and V22=V40+|VTP|=V21−VTN+|VTP|. The offset voltage VOF of this drive circuit 45 becomes: VOF=−VTN+|VTP|.

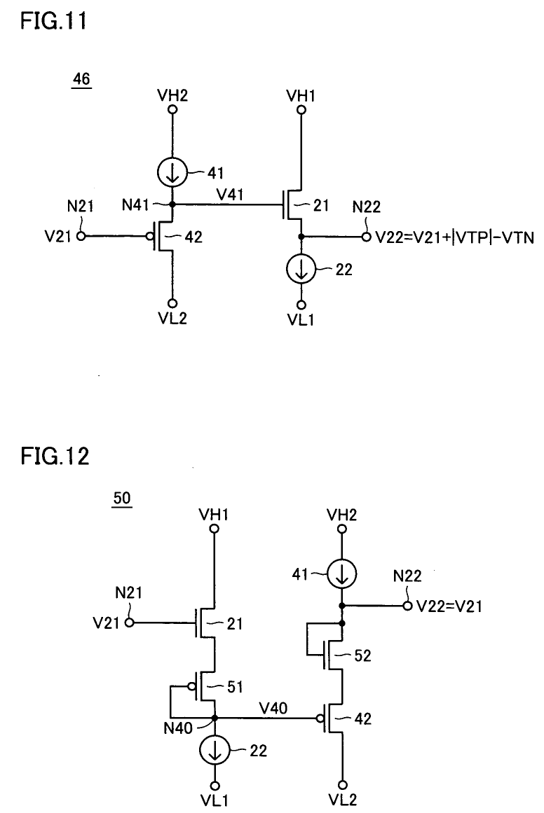

A drive circuit 46 shown in FIG. 11 is a combination of drive circuit 40 of FIG. 9 and drive circuit 25 of FIG. 4. The gate of N type transistor 21 receives a potential V41 of a node N41 between constant current circuit 41 and P type transistor 42. V41=V21+|VTP|, and V22=V41−VTN=V21+|VTP|−VTN. The offset voltage VOF of this drive circuit 46 becomes: VOF=|VTP|−VTN.

A drive circuit 50 shown in FIG. 12 corresponds to drive circuit 45 of FIG. 10 with a P type transistor 51 and an N type transistor 52 added thereto. P type transistor 51 is inserted between the drain of N type transistor 21 and node N40, and has its gate electrode connected to node N40. N type transistor 52 is inserted between node N22 and the source of P type transistor 42, and has its gate electrode connected to node N22. Transistors 51, 52 each constitute a diode element. V40=V21−VTN−|VTP|, and V22=V40+|VTP|+VTN=V21−VTN−|VTP|+|VTP|+VTN=V21.

In this drive circuit 50, the offset voltage VOF becomes 0V when the threshold voltages of N type transistors 21 and 52 are equal and the threshold voltages of P type transistors 51 and 42 are equal. It however does not become 0V if the threshold voltages of N type transistors 21 and 52 are not equal or the threshold voltages of P type transistors 51 and 42 are not equal, due to variation of the threshold voltages of the transistors. The offset voltage VOF is cancelled by the offset compensation circuit formed of capacitors 23, 24 and switches S1-S4 shown in FIG. 4.

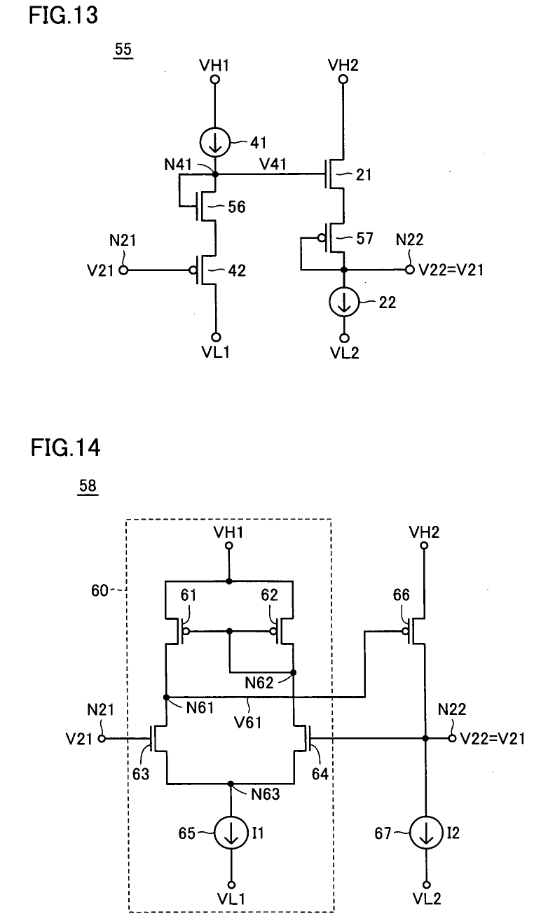

A drive circuit 55 shown in FIG. 13 corresponds to drive circuit 46 of FIG. 11 with an N type transistor 56 and a P type transistor 57 added thereto. N type transistor 56 is inserted between node N41 and the source of P type transistor 42, and has its gate electrode connected to node N41. P type transistor 57 is inserted between the source of N type transistor 21 and node N22, and has its gate electrode connected to node N22. Transistors 56, 57 each constitute a diode element. V41=V21+|VTP|+VTN, and V22=V41−VTN−|VTP|=V21+|VTP|+VTN−VTN−|VTP|=V21.

In this drive circuit 55, the offset voltage VOF becomes 0V when P type transistors 42 and 57 have equal threshold voltages and N type transistors 56 and 21 have equal threshold voltages. It however does not become 0V if the threshold voltages of P type transistors 42 and 57 are not equal or the threshold voltages of N type transistors 56 and 21 are not equal, due to variation of the threshold voltages of the transistors. The offset voltage VOF is cancelled by the offset compensation circuit formed of capacitors 23, 24 and switches S1-S4 shown in FIG. 4.

A drive circuit 58 shown in FIG. 14 includes a differential amplifier circuit 60, a P type transistor 66 and a constant current circuit 67. Differential amplifier circuit 60 includes P type transistors 61, 62, N type transistors 63, 64 and a constant current circuit 65. P type transistors 61, 62 are connected between a line of high potential VH1 and nodes N61, N62, respectively, and have their gates both connected to a node N62. P type transistors 61, 62 constitute a current mirror circuit. N type transistors 63, 64 are connected between nodes N61, N62 and a node N63, respectively, and have their gates receiving potential V21 of node N21 and potential V22 of node N22, respectively. Constant current circuit 65 causes a constant current I1 of a prescribed value to flow from node N63 to a line of low potential VL1. P type transistor 66 is connected between a line of high potential VH2 and node N22, and has its gate receiving a potential V61 of node N61. Constant current circuit 67 causes a constant current 12 of a prescribed value to flow from node N22 to a line of low potential VL2.

Currents flowing through N type transistors 63, 64 have values corresponding to potentials V21, V22 of nodes N21, N22, respectively. N type transistor 64 and P type transistor 62 are connected in series, and P type transistors 61 and 62 constitute a current mirror circuit. Thus, a current having a value corresponding to potential V22 of node N22 flows through P type transistor 61. If V22 is higher than V21, the current flowing through P type transistor 61 becomes greater than the current flowing through N type transistor 63. Potential V61 of node N61 increases, the current flowing through P type transistor 66 decreases, and accordingly, V22 decreases. If V22 is lower than V21, the current flowing through P type transistor 61 becomes smaller than the current flowing through N type transistor 63. Potential V61 of node N61 decreases, the current flowing through P type transistor 66 increases, and accordingly, V22 increases.

Thus, V22 becomes equal to V21, and the offset voltage VOF becomes 0V. V22 however does not become equal to V21 if there is variation in transistor characteristic, which may be, for example, variation in threshold voltage of transistors 63 and 64. In this case, the difference of the threshold voltages of two transistors 63 and 64 becomes the offset voltage VOF, which is cancelled by the offset compensation circuit formed of capacitors 23, 24 and switches S1-S4 shown in FIG. 4.

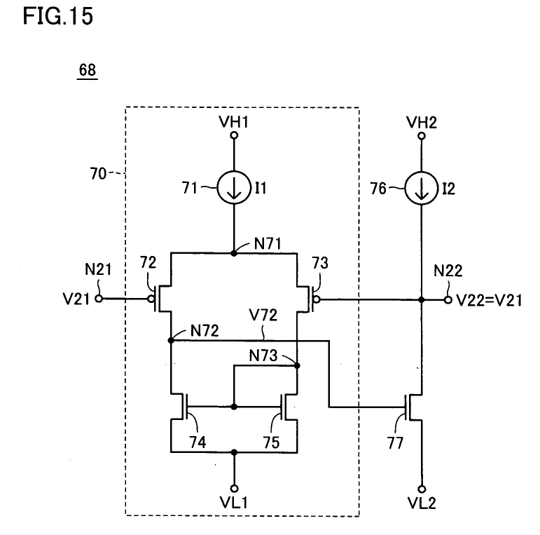

A drive circuit 68 shown in FIG. 15 includes a differential amplifier circuit 70, a constant current circuit 76 and an N type transistor 77. Differential amplifier circuit 70 includes a constant current circuit 71, P type transistors 72, 73 and N type transistors 74, 75. Constant current circuit 71 causes a constant current I1 of a prescribed value to flow from a line of high potential VH1 to a node N71. P type transistors 72, 73 are connected between node N71 and nodes N72, N73, respectively, and have their gates receiving potential V21 of node N21 and potential V22 of node N22, respectively. N type transistors 74, 75 are connected between nodes N72, N73 and a line of low potential VL1, respectively, and have their gates both connected to node N73. N type transistors 74 and 75 constitute a current mirror circuit. Constant current circuit 76 causes a constant current I2 of a prescribed value to flow from a line of high potential VH2 to node N22. N type transistor 77 is connected between node N22 and a line of low potential VL2, and has its gate receiving a potential V72 of node N72.

Currents flowing through P type transistors 72, 73 have values corresponding to potentials V21, V22 of nodes N22, N22, respectively. P type transistor 73 and N type transistor 75 are connected in series, and N type transistors 74 and 75 constitute a current mirror circuit. Thus, a current having a value corresponding to potential V22 of node N22 flows through N type transistor 74. If V22 is higher than V21, the current flowing through N type transistor 74 becomes smaller than the current flowing through P type transistor 72. Potential V72 of node N72 increases, the current flowing through N type transistor 77 increases, and thus, V22 decreases. If V22 is lower than V21, the current flowing through N type transistor 74 becomes greater than the current flowing through P type transistor 72. Potential V72 of node N72 decreases, the current flowing through N type transistor 77 decreases, and thus, V22 increases.

Accordingly, VO becomes equal to VI, and the offset voltage VOF becomes 0V. V22 however does not become equal to V21 if there is variation in transistor characteristic, which may be, for example, variation in threshold voltage of transistors 72 and 73. In this case, the difference of the threshold voltages of two transistors 72 and 73 becomes the offset voltage VOF, which is cancelled by the offset compensation circuit formed of capacitors 23, 24 and switches S1-S4 shown in FIG. 4.

By replacing the drive circuit 25 of FIG. 4 with any of drive circuits 40, 45, 46, 50, 55, 58, and 68 shown in FIGS. 9-15, and by forming the offset-canceling capacitor 23 with a gate electrode of transistor 21, 42, 63 or 72 to which V21 is input and aluminum interconnection 32 in FIG. 6 formed to cover the gate electrode, effects similar to those of the first embodiment can be obtained.

### Third Embodiment

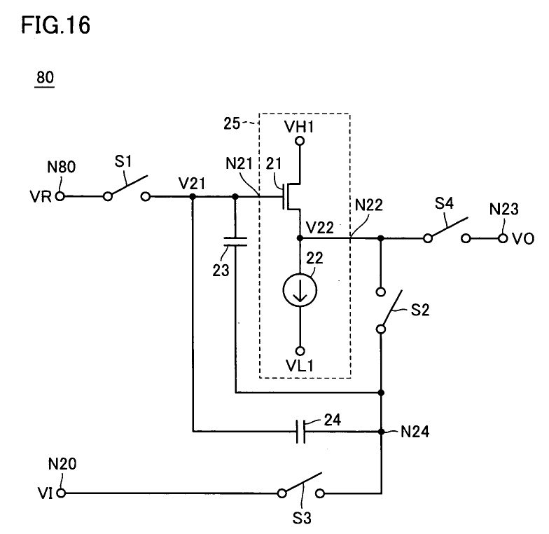

FIG. 16 shows a configuration of an analog amplifier unit circuit 80 according to the third embodiment of the present invention. Referring to FIG. 16, in this analog amplifier unit circuit 80, one terminal of switch S1 of analog amplifier unit circuit 20 in FIG. 4 is connected to a node N80 of a reference potential VR, instead of input node N20. Reference potential VR may be provided directly from the outside of the liquid crystal display, or may be provided from a power supply circuit of low output impedance provided within the liquid crystal display. Input node N20 is connected to one terminal of switch S3. The way of controlling switches S1-S4 is as described in the first embodiment.

Effects of analog amplifier unit circuit 80 are now explained. Firstly, when switches S1 and S2 are turned on, input potential V21 of drive circuit 25 attains reference potential VR, and output potential V22 of drive circuit 25 becomes: V22=V21−VTN=VR−VTN. Capacitors 23, 24 are charged to the offset voltage VOF=−VTN.

Next, switches S1, S2 are turned off, and the offset voltage VOF is maintained at capacitors 23, 24. Switch S3 is then turned on, and the potential of node N24 changes from VR−VOF to VI. The amount of the change is transmitted via capacitors 23, 24 to input node N21 of drive circuit 25. When VI>VR−VOF, the voltage change ΔVI of input node N21 of drive circuit 25 is expressed by the following expression:
ΔV1=[V1−(VR−VOF)]·C1/(C0+C1) (3)

Here, C0 is a capacitance value of the parasitic capacitance of node N21, and C1 is a sum of capacitance values of capacitors 23, 24. When C1/(C0+C1)=1/(1+C0/C1) and C0<<C1, then 1/(1+C0/C1)≈1−C0/C1. When C0/C1=r, then 1−C0/C1=1−r. If this is substituted to the above expression (3), the following expression is obtained:
ΔV1=[VI−(VR−VOF)]·(1−r) (4)

Input potential V21 of drive circuit 25 attains a potential of reference potential VR added with ΔV1, i.e., VR+ΔV1, which is expressed by the following expression:

$$\begin{matrix}V21 = VR + Δ V1 = VR + [ VI - ( VR - VOF ) ] \cdot ( 1 - r ) \\ = VR + VI - VR + VOF - [ VI - ( VR - VOF ) ] \cdot r \\ = VI + VOF - r \cdot VOF - r \cdot ( VI - VR )\end{matrix} \qquad ( 5 )$$

When the similar calculation is conducted for analog amplifier unit circuit 20 of FIG. 4, the result becomes as follows:

$$\begin{matrix}V21 = VI + VOF - VOF \cdot C0 \cdot ( C0 + C1 ) \\ = VI + VOF - VOF \cdot ( C0 / C1 ) / ( C0 / C1 + 1 ) \\ = VI + VOF - VOF \cdot r / ( 1 + r ) \\ \approx VI + VOF - VOF \cdot r \cdot ( 1 - r ) \\ = VI + VOF - VOF \cdot ( r - {r}^{2} )\end{matrix}$$

Here, when r²≈0, the following expression is obtained:
V21≈VI+VOF−r·VOF (6)

When comparing the expression (5) with the expression (6), V21 of analog amplifier unit circuit 80 of FIG. 16 is smaller than V21 of analog amplifier unit circuit 20 of FIG. 4 by the fourth term [−r·(VI−VR)] of the expression (5). This value however becomes negligible when r is made small.

If the same gradation potential VG is applied from gradation potential generating circuit 16 shown in FIG. 3 to a great number of analog amplifier unit circuits 20, the load capacitance value of gradation potential generating circuit 16 becomes a total sum of input capacitance values C0 of the great number of analog amplifier unit circuits 20. This means that a long period of time is required for stabilization of gradation potential VG. When analog amplifier unit circuit 20 is replaced with analog amplifier unit circuit 80 shown in FIG. 16, however, the input capacitance of analog amplifier unit circuit 80 is charged with reference potential VR. This considerably reduces the load capacitance value of gradation potential generating circuit 16, so that gradation potential VG is stabilized in a short period of time.

### Fourth Embodiment

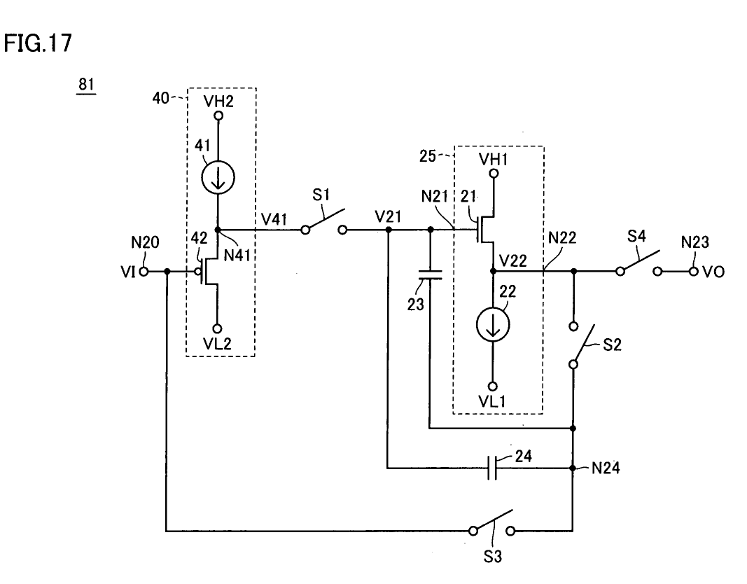

FIG. 17 shows a configuration of an analog amplifier unit circuit 81 according to the fourth embodiment of the present invention, which is to be contrasted with FIG. 4. Referring to FIG. 17, analog amplifier unit circuit 81 differs from analog amplifier unit circuit 20 of FIG. 4 in that drive circuit 40 of FIG. 9 is added between input node N20 and one terminal of switch S1. The gate electrode of P type transistor 42 is connected to input node N20, and node N41 between constant current circuit 41 and P type transistor 42 is connected to the one terminal of switch S1. Although N type transistor 21 needs to drive data line 6, P type transistor 42 only needs to drive N type transistor 21. Thus, the size of P type transistor 42 is set sufficiently smaller than the size of N type transistor 21, and the input capacitance value of P type transistor 42 is also sufficiently smaller than the input capacitance value of N type transistor 21. The way of controlling switches S1-S4 are as explained in the first embodiment.

When VR of the expression (4) is replaced with V41=VI+|VTP|, V21 is expressed by the following expression:

$$\begin{matrix}V21 = VI + VOF - r \cdot VOF - r \cdot ( VI - VI - \vert VTP \vert ) \\ = VI + VOF - r \cdot VOF + r \cdot \vert VTP \vert\end{matrix} \qquad ( 7 )$$

Comparing the expression (7) with the expression (6), V21 of analog amplifier unit circuit 81 of FIG. 17 is greater than V21 of analog amplifier unit circuit 20 of FIG. 4 by the fourth term r·|VTP| of the expression (7). Since VOF (=VTN) is generally set approximately equal to |VTP|, the third term is cancelled with the fourth term, and thus, the offset voltage VOF is compensated.

In the fourth embodiment, the load capacitance value of gradation potential generating circuit 16 becomes considerably small, and gradation potential VG is stabilized in a short period of time.

### Fifth Embodiment

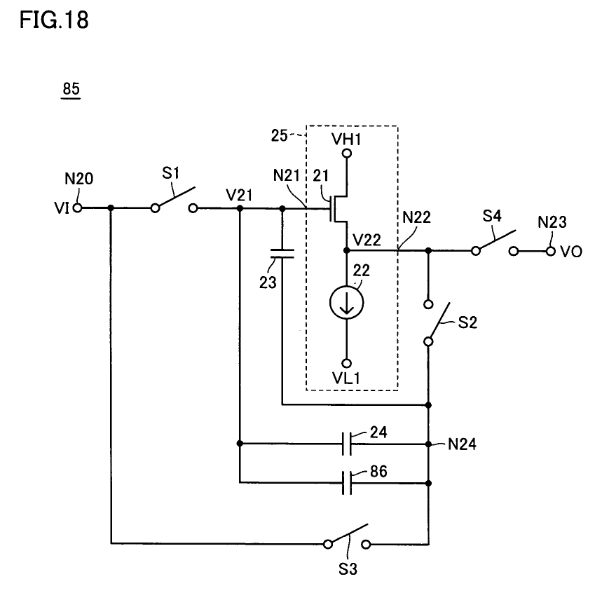

FIG. 18 shows a configuration of an analog amplifier unit circuit 85 according to the fifth embodiment of the present invention, which is to be contrasted with FIG. 4. Referring to FIG. 18, analog amplifier unit circuit 85 differs from analog amplifier unit circuit 20 of FIG. 4 in that a capacitor 86 is additionally provided. Capacitor 86 is connected in parallel with capacitor 24.

When the capacitance value of the parasitic capacitance of node N21 is represented as C21 and the capacitance values of capacitors 23, 24, 86 are represented as C23, C24, C86, respectively, voltage loss ΔV having been explained in the first embodiment is expressed by the following expression:
ΔV=VOF·C21/(C21+C23+C24+C86) (8)

In this analog amplifier unit circuit 85, the parasitic capacitance of the gate electrode of N type transistor 21 is used as capacitor 23, and further, the parasitic capacitance of one electrode (the one connected to node N21) of capacitor 24 is used as capacitor 86. Thus, C21 becomes sufficiently small, and ΔV also becomes sufficiently small.

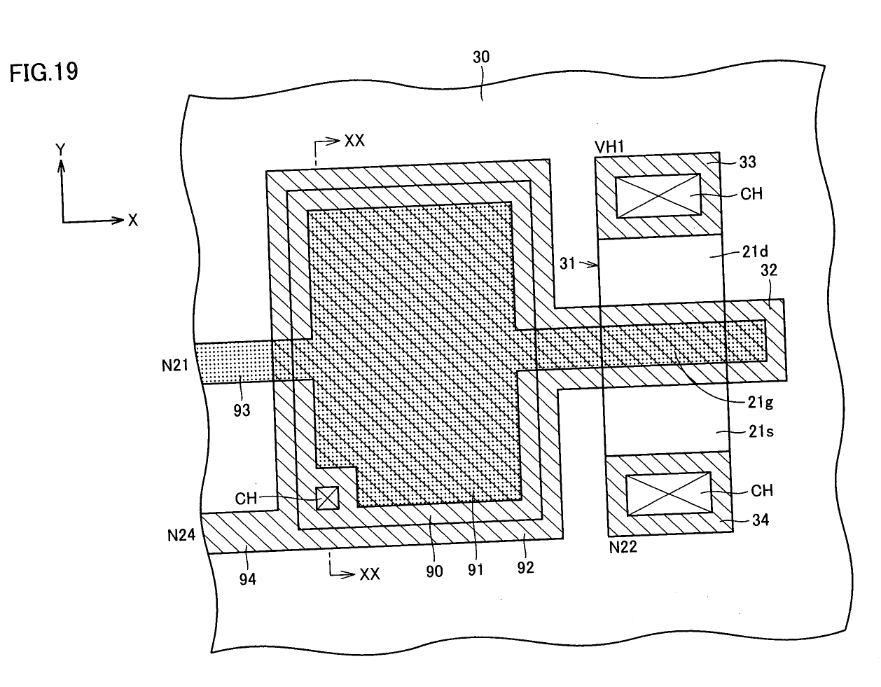

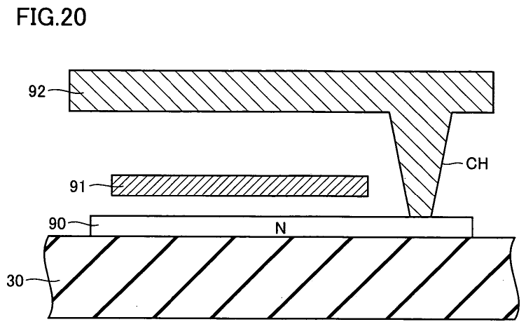

FIG. 19 shows a layout of N type transistor 21 and capacitors 23, 24, 86 shown in FIG. 18, and FIG. 20 is a cross sectional view taken along the line XX-XX in FIG. 19. Referring to FIGS. 19 and 20, a strip-shaped polysilicon thin film 31 extending in the Y direction in the figure is formed on a surface of a glass substrate 30, and a gate electrode 21g extending in the X direction in the figure is formed above the center portion of polysilicon thin film 31, with an insulating layer (not shown) interposed therebetween. Using gate electrode 21g as a mask, an impurity is introduced into polysilicon thin film 31. The polysilicon thin film on one side of gate electrode 21g becomes a drain 21d, and the polysilicon thin film on the other side of gate electrode 21g becomes a source 21s.

Gate electrode 21g has its ends extending beyond the region of polysilicon thin film 31. Drain 21d is connected via a contact hole CH and an aluminum interconnection 33 to a line of high potential VH1, and source 21s is connected via a contact hole CH and an aluminum interconnection 34 to node N22. An aluminum interconnection 32 is formed above gate electrode 21g, with an insulating layer (not shown) interposed therebetween. Aluminum interconnection 32 is formed to cover gate electrode 21g. Gate electrode 21g constitutes one electrode of capacitor 23, while aluminum interconnection 32 constitutes the other electrode of capacitor 23.

Further, a rectangular polysilicon film 90 is formed on the surface of glass substrate 30, adjacent to the strip-shaped polysilicon thin film 31. Polysilicon film 90 is doped, e.g., with an N type impurity to be a conductor. An approximately rectangular electrode 91 is formed above polysilicon film 90, with an insulating layer (not shown) interposed therebetween. Electrode 91 is formed of the same conductor layer as gate electrode 21g, and smaller in size than polysilicon film 90. A rectangular aluminum electrode 92 is formed above electrode 91, with an insulating layer (not shown) interposed therebetween. Aluminum electrode 92 is formed to cover polysilicon film 90 and electrode 91.

Electrode 91 is connected to gate electrode 21g, and also connected via an interconnection 93 to node N21. Aluminum electrode 92 is connected via a contact hole CH to polysilicon film 90, and also connected via aluminum interconnection 94 to node N24. Electrode 91 constitutes both one electrodes of capacitors 24, 86. Polysilicon film 90 and aluminum electrode 92 constitute the other electrodes of capacitors 24, 86, respectively.

As explained above in conjunction with FIG. 6, there exists an electric field between gate electrode 21g and electrode 91 and their surroundings. This electric field causes parasitic capacitance. Thus, in the fifth embodiment, aluminum electrode 92 is formed to cover electrode 91, to reduce the parasitic capacitance caused by the electric field on the side and upper surfaces of electrode 91, and the capacitance between electrode 91 and aluminum electrode 92 is used as the offset-canceling capacitor 86. In other words, the electric field on the side and upper surfaces of electrode 91, having otherwise affected adversely, is now made to have a positive influence, of which effect is profound.

In the fifth embodiment, aluminum electrode 92 is formed to cover one electrode 91 of offset-compensating capacitor 24, and the capacitance between electrode 91 and aluminum electrode 92 is used as offset-compensating capacitor 86. Accordingly, the parasitic capacitance of gate electrode 21g of input transistor 21 can be made small, and the offset voltage can be cancelled accurately, without increasing the area occupied by capacitor 24.

Although the present invention has been described and illustrated in detail, it is clearly understood that the same is by way of illustration and example only and is not to be taken by way of limitation, the spirit and scope of the present invention being limited only by the terms of the appended claims.

1. A drive circuit having offset compensation capability, comprising:
a drive circuit, including a first transistor having a gate electrode connected to an input node, and outputting a potential corresponding to a potential of said input node to an output node; and
an offset compensation circuit, including a first capacitor charged to an offset voltage of said drive circuit, and compensating said offset voltage;
said first capacitor including
a first electrode corresponding to the gate electrode of said first transistor, and
a second electrode provided to face said first electrode.

2. The drive circuit having offset compensation capability according to claim 1, wherein
said first transistor includes a semiconductor thin film formed on a surface of an insulator substrate,
said gate electrode is formed on a surface of said semiconductor thin film with an insulating layer interposed therebetween, and
the second electrode of said first capacitor is formed on a surface of said gate electrode with an insulating layer interposed therebetween.

3. The drive circuit having offset compensation capability according to claim 1, wherein
said offset compensation circuit includes
a first switching circuit that provides an input potential to said input node, connects the second electrode of said first capacitor to said output node, and charges said first capacitor to said offset voltage, and
a second switching circuit that provides said input potential to the second electrode of said first capacitor.

4. The drive circuit having offset compensation capability according to claim 1, wherein
said offset compensation circuit includes
a first switching circuit that provides a reference potential to said input node, connects the second electrode of said first capacitor to said output node, and charges said first capacitor to said offset voltage, and
a second switching circuit that provides an input potential to the second electrode of said first capacitor.

5. The drive circuit having offset compensation capability according to claim 1, wherein
said offset compensation circuit includes
a sub drive circuit that outputs a potential corresponding to an input potential,
a first switching circuit that provides an output potential of said sub drive circuit to said input node, connects the second electrode of said first capacitor to said output node, and charges said first capacitor to said offset voltage, and
a second switching circuit that provides said input potential to the second electrode of said first capacitor.

6. The drive circuit having offset compensation capability according to claim 1, wherein said offset compensation circuit further includes a second capacitor that is connected in parallel with said first capacitor.

7. The drive circuit having offset compensation capability according to claim 1, wherein
said drive circuit further includes a first constant current circuit that is connected between said output node and a line of a first power supply potential, and
said first transistor has a drain connected to a line of a second power supply potential and a source connected to said output node.

8. The drive circuit having offset compensation capability according to claim 1, wherein
said first transistor is of a first conductivity type,
said drive circuit further includes
a second transistor of a second conductivity type having a drain connected to said output node and a source connected to a line of a first power supply potential,
a first constant current circuit that is connected between a line of a second power supply potential and said output node, and
a second constant current circuit that is connected between a gate electrode of said second transistor and a line of a third power supply potential, and
said first transistor has a drain connected to a line of a fourth power supply potential and a source connected to the gate electrode of said second transistor.

9. The drive circuit having offset compensation capability according to claim 8, wherein
said drive circuit further includes
a third transistor of the second conductivity type that is inserted between a source of said first transistor and the gate electrode of said second transistor and has a gate electrode connected to the gate electrode of said second transistor, and
a fourth transistor of the first conductivity type that is inserted between said output node and a source of said second transistor and has a gate electrode connected to said output node.

10. The drive circuit having offset compensation capability according to claim 1, wherein
said drive circuit includes
a second transistor connected between a line of a first power supply potential and said output node,
a constant current circuit connected between said output node and a line of a second power supply potential, and
a differential amplifier circuit including said first transistor and a third transistor having a gate electrode connected to said output node, and controlling a potential of the gate electrode of said second transistor such that a potential of said output node matches a potential of said input node.

11. A liquid crystal display, comprising:
the drive circuit having offset compensation capability recited in claim 1; and
a liquid crystal cell having optical transmittance changed in accordance with an output potential of said drive circuit having offset compensation capability.

12. A drive circuit having offset compensation capability, comprising:
a drive circuit, including a transistor having a gate electrode connected to an input node, and outputting a potential corresponding to a potential of said input node to an output node; and
an offset compensation circuit, including a capacitor charged to an offset voltage of said drive circuit, and compensating said offset voltage;
said capacitor including
a first electrode connected to the gate electrode of said transistor,
a second electrode formed on one side of said first electrode with an insulating layer interposed therebetween, and
a third electrode formed on another side of said first electrode with an insulating layer interposed therebetween, and connected to said second electrode.

13. The drive circuit having offset compensation capability according to claim 12, wherein
said transistor includes a part of a semiconductor thin film formed on a surface of an insulator substrate,
said gate electrode includes a part of a first conductor layer formed on a surface of said semiconductor thin film with an insulating layer interposed therebetween,
said first electrode includes another part of said first conductor layer,
said second electrode includes another part of said semiconductor thin film, and
said third electrode includes a part of a second conductor layer formed on a surface of said first conductor layer with an insulating layer interposed therebetween.

14. A drive circuit having offset compensation capability, comprising:
a drive circuit, including a transistor having a gate electrode connected to an input node, and outputting a potential corresponding to a potential of said input node to an output node; and
an offset compensation circuit, including a capacitor charged to an offset voltage of said drive circuit, and compensating said offset voltage;
said capacitor including
a first electrode corresponding to the gate electrode of said transistor,
a second electrode provided to face said first electrode,
a third electrode,
a fourth electrode formed on a surface of said third electrode with an insulating layer interposed therebetween, and connected to said first electrode, and
a fifth electrode formed on a surface of said fourth electrode with an insulating layer interposed therebetween, and connected to said second and third electrodes.

15. The drive circuit having offset compensation capability according to claim 14, wherein
said transistor includes a part of a semiconductor thin film formed on a surface of an insulator substrate,
said gate electrode includes a part of a first conductor layer formed on a surface of said semiconductor thin film with an insulating layer interposed therebetween,
said second gate electrode includes a part of a second conductor layer formed on a surface of said first conductor layer with an insulating layer interposed therebetween,
said third electrode includes another part of said semiconductor thin film,
said fourth electrode includes another part of said first conductor layer, and
said fifth electrode includes another part of said second conductor layer.
